(19) United States
(12) Patent Application Publication
(10) Pub. No.: US 2026/0299811 A1
(43) Pub. Date: Oct. 1, 2026

(54) PORTION METADATA FOR A DEDUPLICATION STORAGE SYSTEM

(71) Applicant: Hewlett Packard Enterprise Development LP, Spring, TX (US)

(72) Inventors: Noor Elreidy, Bristol (GB); Richard Phillip Mayo, Bristol (GB)

(21) Appl. No.: 19/092,567

(22) Filed: Mar. 27, 2025

(51) Int. Cl. G06F 3/06

(52) U.S. Cl. CPC G06F 3/0641; G06F 3/0608; G06F 3/0652; G06F 3/067

(57) ABSTRACT

Example implementations relate to deduplication operations in a storage system. An example includes receiving a first portion of an initial data stream to be stored in a persistent storage of a deduplication storage system, where the first portion includes a set of multiple data units arranged in a received order. The example also includes generating a set of unit fingerprints for the set of data units in the first portion, and generating a first portion fingerprint as a function of the set of unit fingerprints. The example also includes storing the set of data units in a container entity group (CEG) object, storing portion metadata that includes the first portion fingerprint in a container index, and storing unit metadata that includes the set of unit fingerprints in a header of the CEG object.

### BACKGROUND

Data reduction techniques can be applied to reduce the amount of data stored in a storage system. An example data reduction technique includes data deduplication. Data deduplication identifies data units that are duplicative, and seeks to reduce or eliminate the number of instances of duplicative data units that are stored in the storage system.

### BRIEF DESCRIPTION OF THE DRAWINGS

Some implementations are described with respect to the following figures.

FIG. 1 is a schematic diagram of an example storage system, in accordance with some implementations.

FIG. 2 is an illustration of example data structures, in accordance with some implementations.

FIG. 3 is an illustration of an example process, in accordance with some implementations.

FIGS. 4A-4F are illustrations of example operations, in accordance with some implementations.

FIGS. 5A-5B are illustrations of an example process, in accordance with some implementations.

FIGS. 6A-6H are illustrations of example operations, in accordance with some implementations.

FIG. 7 is an illustration of an example process, in accordance with some implementations.

FIGS. 8A-8D are illustrations of example operations, in accordance with some implementations.

FIG. 9 is a schematic diagram of an example computing device, in accordance with some implementations.

FIG. 10 is an illustration of an example process, in accordance with some implementations.

FIG. 11 is a diagram of an example machine-readable medium storing instructions in accordance with some implementations.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a storage system may receive a data stream from an external data source or system, and may store or “backup” a copy of the data stream. For example, the data stream may be generated by a backup system or program during a backup of a collection of data. The data stream may include discrete data units (or “chunks”) that are generated by the data source. Additionally (or alternatively), the data stream may include fingerprints that represent the data units, and that are generated by the external data source. As used herein, the term “fingerprint” refers to a value derived by applying a function on the content of the data unit (where the “content” can include the entirety or a subset of the content of the data unit). An example of a function that can be applied includes a hash function that produces a hash value based on the content of an incoming data unit. Examples of hash functions include cryptographic hash functions such as the Secure Hash Algorithm 2 (SHA-2) hash functions, e.g., SHA-224, SHA-256, SHA-384, etc. In other examples, other types of hash functions or other types of fingerprint functions may be employed.

In some examples, the storage system may backup at least a portion of the data stream in deduplicated form, to thereby reduce the amount of storage space occupied by storage of the data stream. The storage system may create a “backup item” to represent a data stream in a deduplicated form. The storage system may perform a deduplication process including comparing the fingerprints of incoming data units to fingerprints of stored data units, and determining which incoming data units (if any) are duplicates of previously stored data units (e.g., when the comparison indicates matching fingerprints). In the case of data units that are duplicates, the storage system may store references to previously stored data units instead of storing the duplicate incoming data units. A process for receiving and deduplicating an inbound data stream may be referred to herein as a “data ingest” process of a storage system.

A “storage system” can include a storage device or an array of storage devices. A storage system may also include storage controller(s) that manage(s) access of the storage device(s). A “data unit” can refer to any portion of data that can be separately identified in the storage system. In some cases, a data unit can refer to a chunk, a collection of chunks, or any other portion of data. In some examples, a storage system may store data units in persistent storage. Persistent storage can be implemented using one or more of persistent (e.g., nonvolatile) storage device(s), such as disk-based storage device(s) (e.g., hard disk drive(s) (HDDs)), solid state device(s) (SSDs) such as flash storage device(s), or the like, or a combination thereof. A “controller” can refer to a hardware processing circuit, which can include any or some combination of a microprocessor, a core of a multi-core microprocessor, a microcontroller, a programmable integrated circuit, a programmable gate array, a digital signal processor, or another hardware processing circuit. Alternatively, a “controller” can refer to a combination of a hardware processing circuit and machine-readable instructions (software and/or firmware) executable on the hardware processing circuit.

In some examples, a deduplication storage system may use metadata structures for processing inbound data streams (e.g., backup items). For example, such metadata structures may include data recipes (also referred to herein as “manifests”) that specify the order in which particular data units are received for each backup item. Further, such metadata may include item metadata to represent each received backup item (e.g., a data stream) in a deduplicated form. The item metadata may include identifiers for a set of manifests, and may indicate the sequential order of the set of manifests. The processing of each backup item may be referred to herein as a “backup process.” Subsequently, in response to a read request, the deduplication system may use the item metadata and the set of manifests to determine the received order of data units, and may thereby recreate the original data stream of the backup item. Accordingly, the set of manifests may be a representation of the original backup item.

In some examples, the manifests may include a sequence of records, with each record representing a particular set of data unit(s). The records of the manifest may include one or more fields that identify container indexes that include metadata for the data units. For example, a container index may include one or more metadata fields that specify fingerprints for the stored data units, storage address information (e.g., containers, offsets, etc.) for the stored data units, compression and/or encryption characteristics of the stored data units, and so forth. Further, the container index may include reference counts that indicate the number of manifests that reference each data unit.

In some examples, upon receiving a data unit (e.g., in a data stream), it may be matched against one or more container indexes to determine whether an identical data unit is already stored in a container of the storage system. For example, the storage system may compare the fingerprint of the received data unit against the fingerprints in one or more container indexes. As used herein, the term “matching operation” may refer to an operation to compare fingerprints of a collection of multiple data units (e.g., from a particular backup data stream) against fingerprints stored in one or more container indexes. If no matching fingerprints are found in the searched container index(es), the received data unit may be stored in a container entity group (“CEG”) object, and a metadata entry for the received data unit may be added to a container index associated with that CEG object. However, if a matching fingerprint is found in a searched container index, it may be determined that a data unit identical to the received data unit is already stored in an existing CEG object. In response to this determination, the reference count of the corresponding entry may be incremented, and the received data unit is not stored in a CEG object (as it is already present in the existing CEG object), thereby avoiding storing a duplicate data unit in the storage system.

In some examples, a data stream may be divided into data units of a uniform size. Further, the size that is elected for the data units may affect the performance of the deduplication storage system. For example, if the size of a received data unit is relatively small, the likelihood of finding an exact match in the stored data units may be relatively higher (e.g., in comparison to a received data unit of a larger size), thereby increasing the effectiveness of attempting to deduplicate the data unit. However, if the size of the received data unit is relatively small, the size ratio of the data unit to its metadata (e.g., fingerprint, reference count, location, etc.) is also relatively small, thereby reducing the amount of storage space that is saved by storing the data unit in deduplicated form. That is, the storage space consumed by metadata for deduplicating a given collection of data is greater when the data is broken into smaller data units for deduplication and smaller when the data is broken into larger data units for deduplication. In contrast, if the size of a received data unit is relatively large, the likelihood of finding an exact match in the stored data units may be relatively smaller (e.g., in comparison to a received data unit of a smaller size), thereby reducing the effectiveness of attempting to deduplicate the data unit. However, if the size of the received data unit is relatively large, the size ratio of the data unit to its metadata (e.g., fingerprint, reference count, location, etc.) is also relatively large, thereby increasing the amount of storage space that is saved by storing the data unit in deduplicated form. That is, the storage space consumed by metadata for deduplicating a given collection of data is smaller when the data is broken into larger data units for deduplication and greater when the data is broken into smaller data units for deduplication.

In accordance with some implementations of the present disclosure, a controller of a deduplication storage system may receive a data stream portion including a sequence of multiple data units. Each data unit may be represented by metadata (also referred to herein as a “unit metadata”) that is specific to that data unit. For example, the unit metadata may include a fingerprint that represents the data unit (also referred to herein as a “unit fingerprint”). Further, the portion may be represented by metadata (also referred to herein as a “portion metadata”) that is specific to that portion. For example, the portion metadata may include a fingerprint that represents the portion as a whole (also referred to herein as a “portion fingerprint”). The controller may generate the portion fingerprint by applying a function to the set of unit fingerprints that represent the data units in the portion.

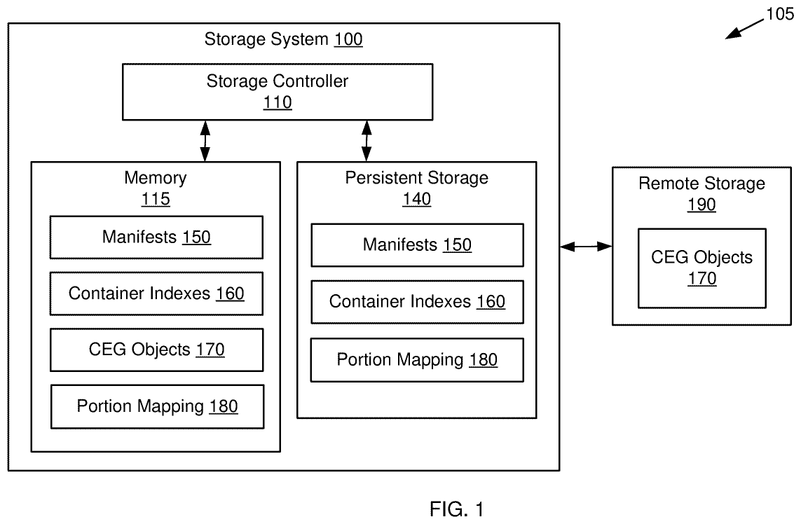

In some implementations, the controller may compare the portion fingerprint to fingerprints stored in a container index. If no matching fingerprints are found in the searched container index, the received portion may be stored in a CEG object, and the portion metadata may be stored in a container index entry. Further, the unit metadata (e.g., the unit fingerprints for the data units included in the portion) may be stored in the CEG object header. Otherwise, if a matching fingerprint is found in a searched container index, it may be determined that an identical portion is already stored in an existing CEG object. In response to this determination, the reference count for the portion may be incremented (e.g., in the container index entry for the portion), and the received portion is not stored in a CEG object (as it is already present in the existing CEG object), thereby avoiding storing a duplicate copy of the portion. In this manner, the storage system may deduplicate the received data using a relatively large size (e.g., as a portion), while only using a single container index entry to represent the entire portion. Further, if it is determined that one or more data units in a received portion no longer match the stored portion, the unit metadata may be extracted from the CEG object header, and the unit metadata may be used to replace the container index entry for the portion with a set of the container index entries for the data units. Accordingly, if the portion metadata is no longer suitable for matching operations, the storage system may modify one or more metadata structures to perform matching operations using unit metadata. Various details of the disclosed techniques are discussed below with reference to FIGS. 1-11.

### FIG. 1—Example Storage System

FIG. 1 shows an example system 105 that includes a storage system 100 and a remote storage 190. The storage system 100 may include a storage controller 110, memory 115, and persistent storage 140, in accordance with some implementations. The storage system 100 may be coupled to the remote storage 190 via a network connection. The remote storage 190 may be a network-based persistent storage facility or service (also referred to herein as “cloud-based storage”). In some examples, use of the remote storage 190 may incur financial charges that are based on the number of individual transfers.

The persistent storage 140 may include one or more non-transitory storage media such as hard disk drives (HDDs), solid state drives (SSDs), optical disks, and so forth, or a combination thereof. The memory 115 may be implemented in semiconductor memory such as random access memory (RAM). In some examples, the storage controller 110 may be implemented via hardware (e.g., electronic circuitry) or a combination of hardware and programming (e.g., comprising at least one processor and instructions executable by the at least one processor and stored on at least one machine-readable storage medium).

In some implementations, the memory 115 may include manifests 150, container indexes 160, container entity group (“CEG”) objects 170, and a portion mapping 180. Further, the persistent storage 140 may store manifests 150, container indexes 160, and the portion mapping 180. The remote storage 190 may persistently store CEG objects 170. Each CEG object 170 may be a container data structure configured to store multiple data units. In some examples, copies of the manifests 150, container indexes 160, and CEG objects 170 may be transferred between some or all of the memory 115, the persistent storage 140, and the remote storage 190 (e.g., via read and write input/output (I/O) operations).

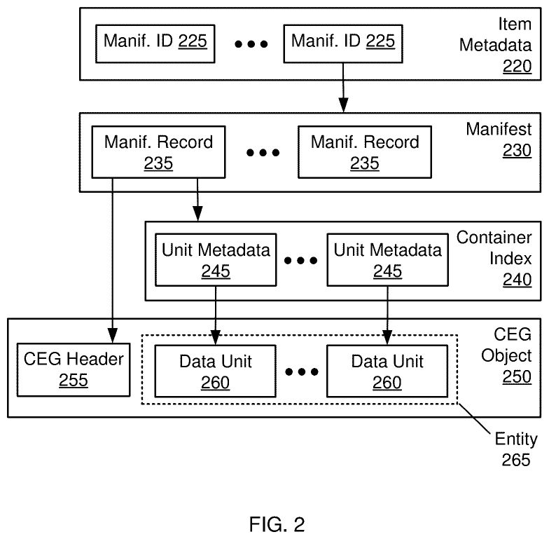

In some implementations, the storage system 100 may perform deduplication of the stored data. For example, the storage controller 110 may receive a data stream portion including a sequence of multiple data units. The storage controller 110 may generate a manifest 150 to record the order in which the data units were received in the portion. The manifest 150 may include pointers or other information indicating other data structures that include metadata for each data unit. For example, the manifest 150 may include, for each data unit, an identifier for the container index 160 associated with the data unit, an identifier for a CEG object 170 associated with the data unit, and so forth. In some implementations, the identifier for the container index 160 may be embedded in (e.g., may be a sub-portion of) the identifier for a CEG object 170. Example implementations of a manifest 150, a container index 160, and CEG objects 170 are discussed further below with reference to FIG. 2.

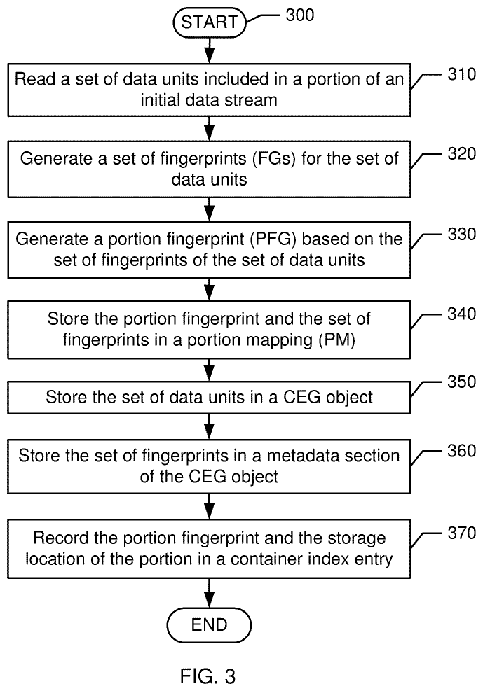

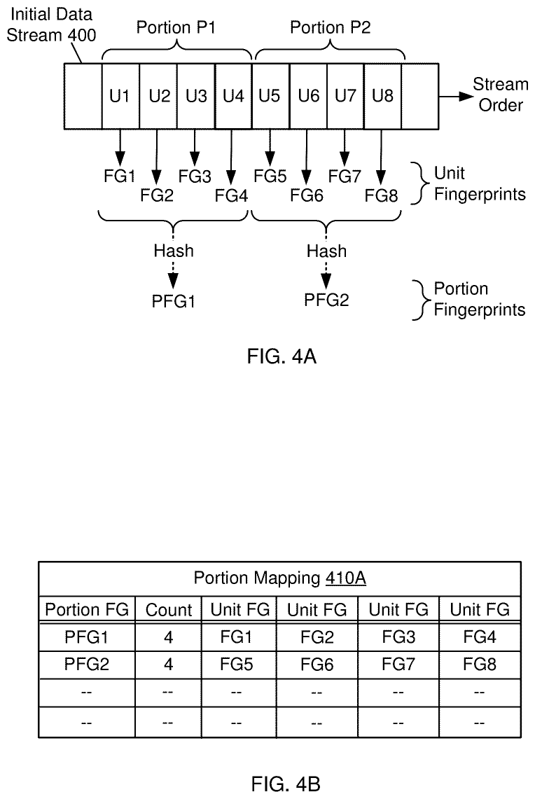

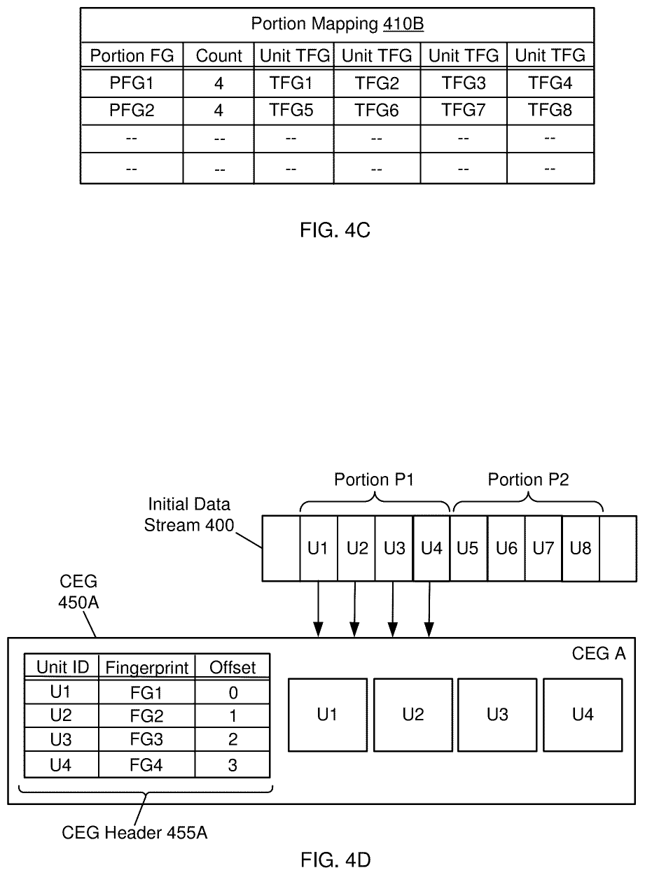

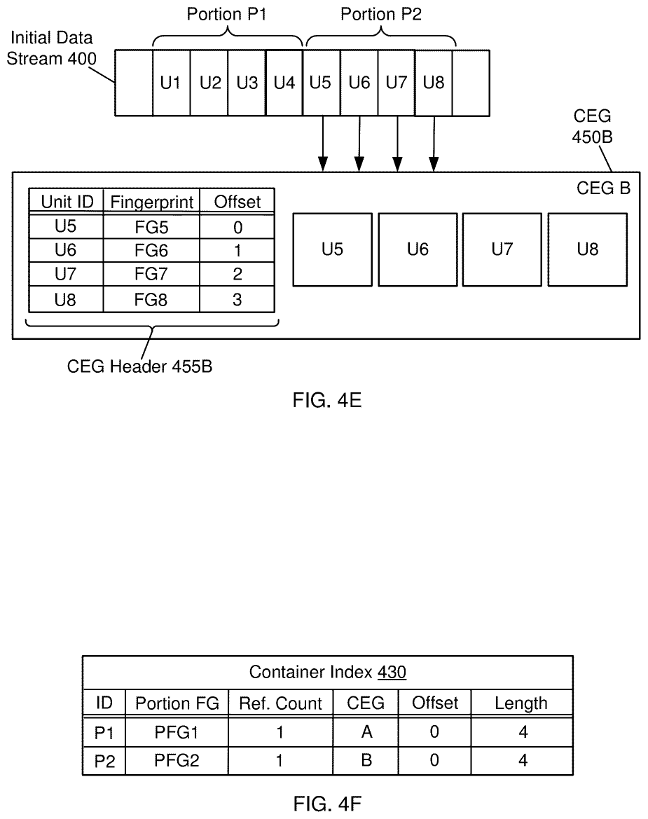

In some implementations, the container index 160 may include an entry to store portion metadata regarding the received portion. For example, the portion metadata may include a portion fingerprint (e.g., a hash) of a stored portion for use in a matching process of a deduplication process. The portion metadata may also include storage address information for the portion (e.g., a location in a particular CEG object 170). Further, the portion metadata may include a reference count for the portion (e.g., indicating the number of manifest records that reference the portion) for use in housekeeping (e.g., to determine whether to delete a stored portion). Furthermore, the portion metadata may include compression information, encryption information, and so forth. In some implementations, the CEG object 170 may include unit metadata for each data unit stored in the CEG object 170. For example, the unit metadata (e.g., stored in a header portion of the CEG object 170) may include a unit fingerprint for each stored data unit. The unit metadata may also include storage address information for each data unit (e.g., an offset location in that CEG object 170). Further, the unit metadata may include compression information, encryption information, and so forth. An example process for storing portion metadata and unit metadata is discussed below with reference to FIGS. 3 and 4A-4F.

In some implementations, the portion mapping 180 may be a data structure including multiple entries (e.g., rows), with each entry identifying a different portion (e.g., a sequence of multiple data units). Further, each entry may include fields or values indicating the data units that are included in the corresponding portion. Example implementations of the portion mapping 180 are discussed further below with reference to FIGS. 4B-4C.

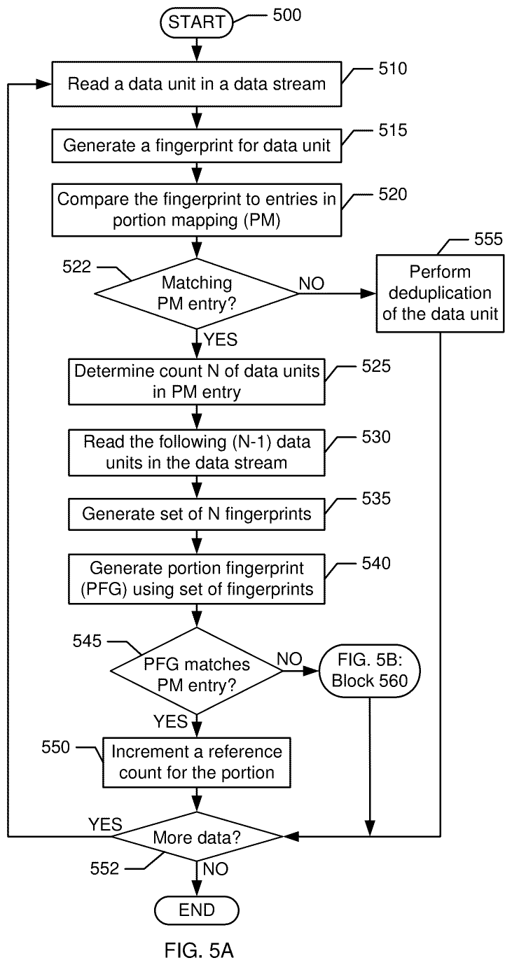

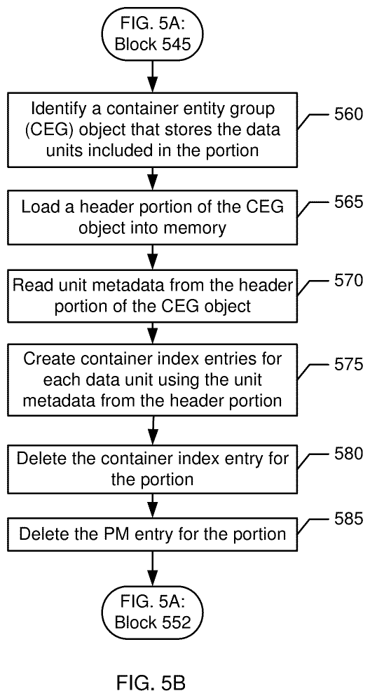

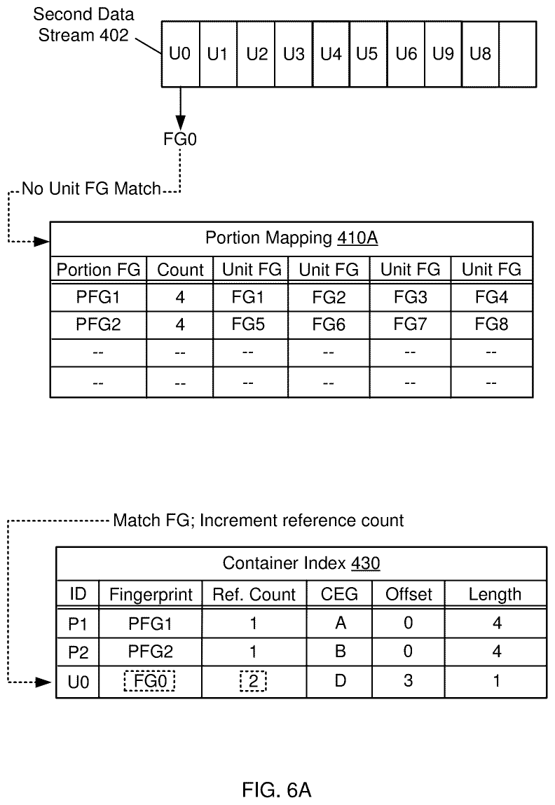

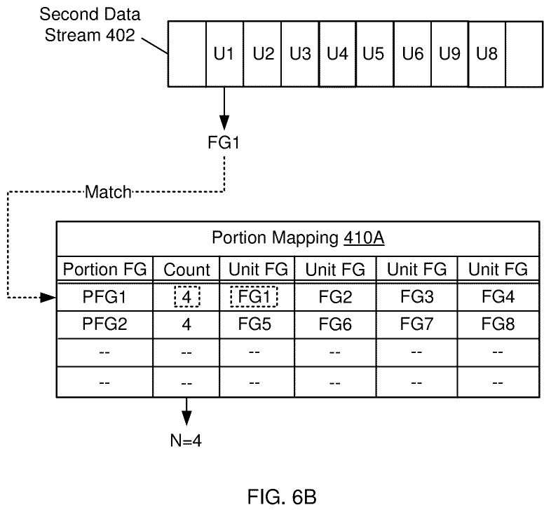

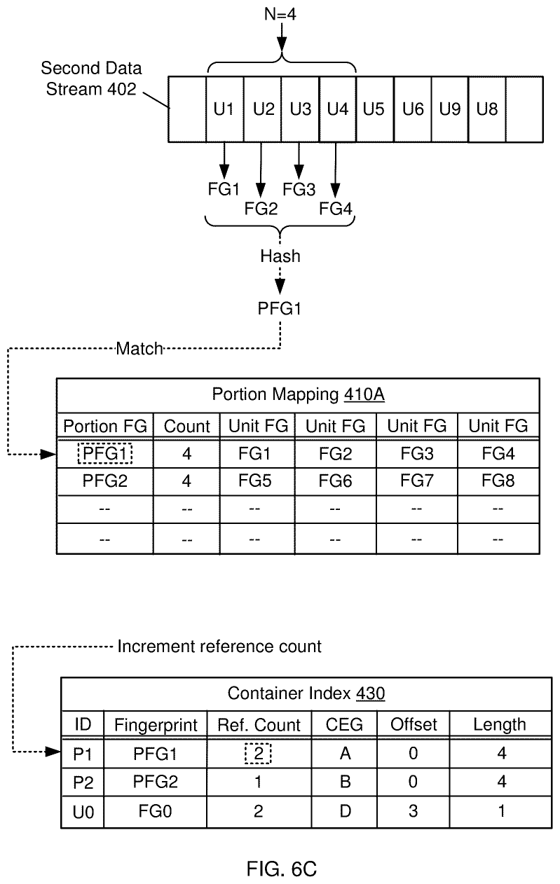

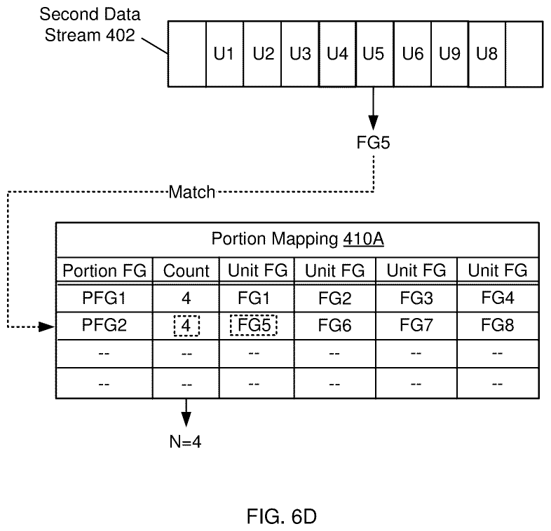

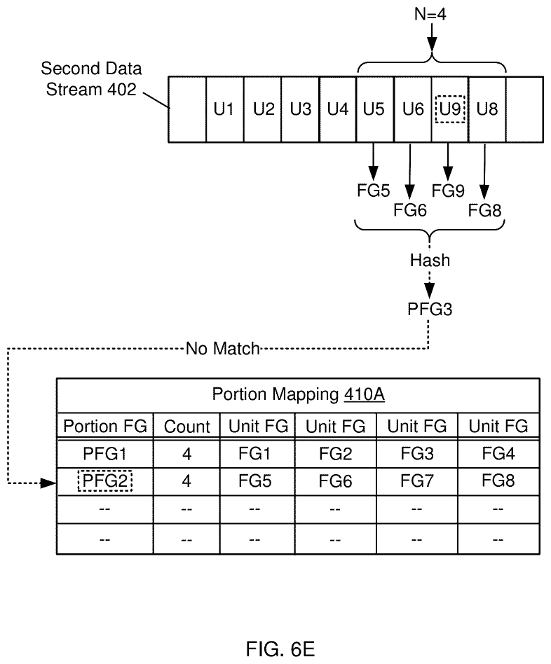

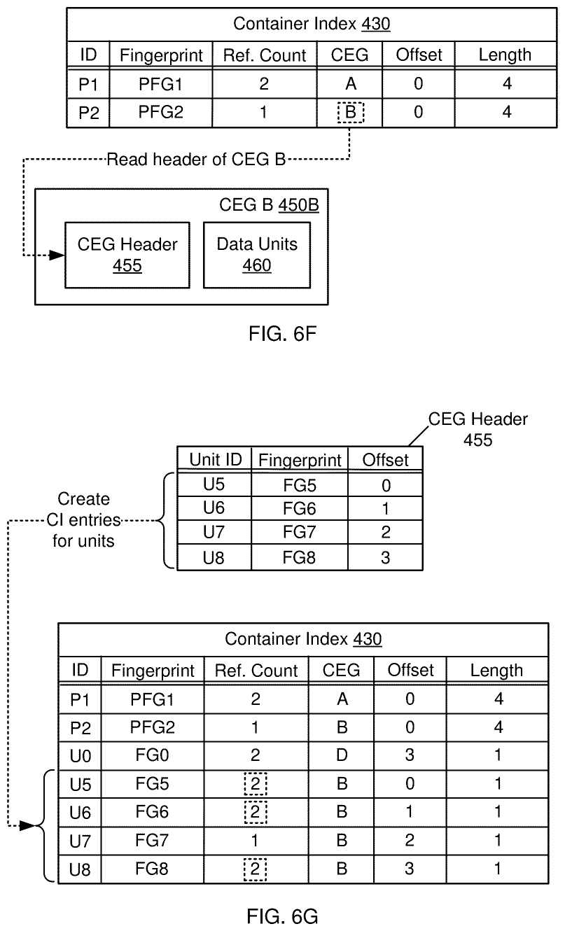

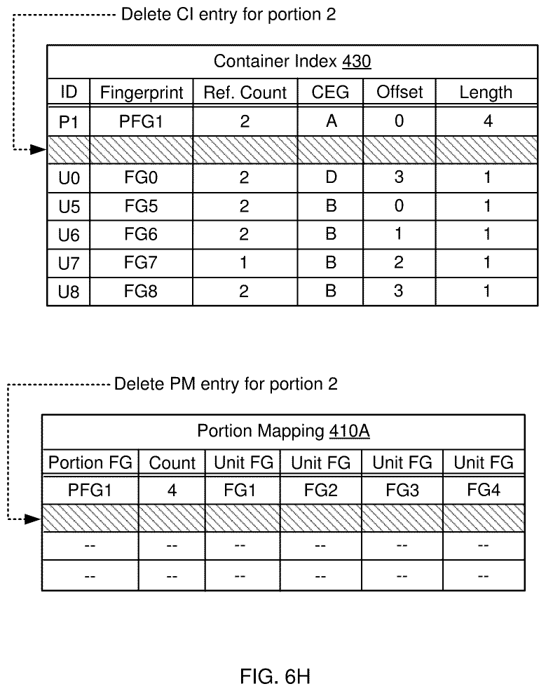

In some implementations, the storage controller 110 may receive a data unit (e.g., in a data stream), and may compare the received data unit to the entries of the portion mapping 180. If the received data unit matches the first data unit listed in a particular entry in the portion mapping 180, the storage controller 110 may read the particular entry to determine the count of data units that are included in the corresponding portion (represented by the particular entry). The storage controller 110 may then read additional data units to obtain a set of received data units (i.e., including the first received data unit) that is equal to the determined count, and may generate a set of unit fingerprints for the set of received data units. The storage controller 110 may then generate a portion fingerprint (PFG) based on the set of unit fingerprints, and may compare the generated PFG to the PFG stored in the particular entry of the portion mapping 180. If the generated PFG matches the stored PFG, the storage controller 110 may determine that the set of received data units is identical to a portion that is already stored in an existing CEG object 170. In response to this determination, the storage controller 110 may access the container index entry for the portion, and may then increment the reference count for the portion. In this manner, the storage controller 110 avoids storing a duplicate copy of the portion. An example process for deduplication using portion metadata is discussed below with reference to FIGS. 5A-6H.

Note that, while FIG. 1 shows one example, implementations are not limited in this regard. For example, it is contemplated that some or all of the manifests 150 and container indexes 160 may be stored in the remote storage 190. In another example, it is contemplated that some or all of the CEG objects 170 may be stored in the persistent storage 140. In yet another example, it is contemplated that the memory 115, persistent storage 140, and/or remote storage 190 may include other data objects or metadata. Further, it is contemplated that the storage system 100 may include additional devices and/or components, fewer components, different components, different arrangements, and so forth.

### FIG. 2—Example Data Structures

FIG. 2 shows an illustration of example data structures used in deduplication, in accordance with some implementations. As shown, the data structures may a manifest 200, a container index 220, and container entity group (“CEG”) objects 250. In some examples, the manifest 200, the container index 220, and the CEG objects 250 may correspond generally to example implementations of a manifest 150, a container index 160, and a CEG object 170 (shown in FIG. 1), respectively. Further, in some examples, the data structures 200, 220, 250 may be generated and/or managed by the storage controller 110 (shown in FIG. 1).

In some implementations, a manifest 200 may include multiples entries or “records” that are associated with different data units (e.g., a sequence of data units received in a data stream). For example, each record in the manifest 200 may include a data unit identifier (“Unit ID”) and a CEG identifier (“CEG ID”). The data unit identifier may be a numerical value (referred to as the “arrival number”) that indicates the sequential order of arrival (also referred to as the “ingest order”) of data units being added to a deduplication storage system (e.g., system 105 shown in FIG. 1). Further, the CEG identifier may identify the CEG object 250 that stores a copy of the data unit. In some implementations, the CEG identifier may include or encode an identifier for the container index 220. For example, as shown in FIG. 2, each CEG identifier (e.g., “xA,” “xB,” “xC”) may include a prefix (e.g., “x”) or other embedded portion that identifies the container index 220 (e.g., container index “x”) that includes metadata for the data units stored in the CEG object that is identified by the CEG identifier.

In some implementations, the container index 220 may comprise a plurality of unit metadata entries 225. Each unit metadata entry 225 may relate to one or more data units 260. In some implementations, each unit metadata entry 225 may include the data unit identifier, a fingerprint, a reference count, a CEG identifier (“CEG ID”), a unit location, and compression information. The data unit and CEG identifiers are discussed above with reference to the manifest 200. The fingerprint may be a value derived by applying a function (e.g., a hash function) to all or some of the content of the data unit. The reference count may indicate the total number of records in the manifests 200 that reference the data unit. The compression information may indicate how the stored data unit is compressed or decompressed (whether compression was used, type of compression code, type of decompression code, decompressed size, a checksum value, etc.). In some examples, during a read operation, the compression information may be used to decompress a requested data unit.

In some implementations, the unit location may indicate the portion of (or position within) the CEG object 250 that stores the data unit (or a set of data units). The unit location may be information stored in a field (or in a combination of multiple fields) that deterministically identifies the storage location of the data unit(s). For example, the unit location may be recorded as two values (e.g., stored in two fields) that respectively identify a particular offset in the CEG object 250, and the data length of the data unit(s) stored at the specified offset. In another example, the unit location may be recorded as a single value (e.g., an offset in the CEG object 250). Other examples are possible.

In some implementations, a CEG object 250 may include a CEG header 240 and one or more data units 260. The header portion 240 may occupy a specified portion of a CEG object 250 (e.g., the first 64 kilobytes of the CEG object). Further, in some implementations, the CEG object 250 may include one or more groupings or “entities” 255, with each entity 255 including multiple data units 260 (e.g., a specified number or size of data units). Each entity 255 may be compressed to reduce its stored size (e.g., compressed as a single object). In some implementations, the CEG header 240 may include one or more header entries 245. Each header entry 245 may include metadata regarding a different data unit 260 (or a set of data units 260) stored in the same CEG object 250. In some implementations, the header entry 245 for a data unit 260 may include a subset of the metadata in the unit metadata entry 225 (in the container index 220) for the same data unit 260. For example, a header entry 245 may include a first subset (i.e., data unit identifier, fingerprint, unit location, and compression information) of the metadata in the unit metadata entry 225, but may exclude a second subset (i.e., the reference count and the CEG identifier) of the metadata in the unit metadata entry 225.

In some implementations, a controller (e.g., storage controller 110 shown in FIG. 1) may use the unit metadata entry 225 (in the container index 220) to access a stored data unit via the container index path. An example processes for reading a data unit using container index metadata (e.g., in a unit metadata entry 225) is discussed below with reference to FIG. 4. Further, the controller may use the header entry 245 (in the CEG header 240) to access the stored data unit via the CEG path. An example processes for reading a data unit using the CEG object metadata (e.g., in the header entry 245) is discussed below with reference to FIG. 5.

Note that, while FIG. 2 shows one example of the data structures 200, implementations are not limited in this regard. For example, it is contemplated that the manifest 200, the container index 220, and the CEG objects 250 may include additional fields or elements, additional data structures, and so forth. In another example, it is contemplated that the unit metadata entry 225 and/or the header entry 245 may include additional fields, fewer fields, different fields, and so forth.

### FIG. 3—Example Process for Generating Metadata

FIG. 3 shows is an example process 300 for generating metadata of a deduplication storage system, in accordance with some implementations. For the sake of illustration, details of the process 300 may be described below with reference to FIGS. 1-2, which show examples in accordance with some implementations. However, other implementations are also possible. In some examples, the process 300 may be performed using the storage controller 110 (shown in FIG. 1). The process 300 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth. In some implementations, the process 300 may be executed by a single processing thread. In other implementations, the process 300 may be executed by multiple processing threads in parallel (e.g., concurrently using the work map and executing multiple housekeeping jobs).

Block 310 may include reading a set of data units included in a portion of an initial data stream. Block 320 may include generating a set of fingerprints (FGs) for the set of data units. Block 330 may include generating a portion fingerprint (PFG) based on the set of fingerprints of the set of data units.

For example, referring to FIG. 4A, a controller (e.g., storage controller 110 shown in FIG. 1) receives an initial data stream 400 to be stored in persistent storage. The initial data stream 400 may be the first or initial instance of a data stream that is received (e.g., during the initial backup of a collection of data), and may include multiple data units that are divided into sets or portions. For example, as shown in FIG. 4A, the initial data stream 400 includes a first portion (“P1”) made up of four data units (“U1,” “U2,” “U3,” “U4”), and also includes a second portion (“P2”) made up of another four data units (“U5,” “U6,” “U7,” “U8”). In some implementations, when receiving an initial instance of a particular data stream, the entire data stream may be divided into portions that each correspond to a single storage entity (e.g., entity 265 shown in FIG. 2). Accordingly, in such implementations, each portion may include a grouping of data units that may be compressed into a single stored entity object. Stated differently, the initial data stream may be divided into portions along the boundaries of the entities that store the data units.

As shown in FIG. 4A, the controller generates unit fingerprints (“FG1” to “FG8”) by applying a function (e.g., a hash function) to the received data units. The controller then generates a first portion fingerprint (“PFG1”) by applying a function to the group of unit fingerprints (“FG1” to “FG4”) for the first portion (“P1”). For example, the first portion fingerprint (“PFG1”) may be generated by applying a hash function to a concatenated version of the unit fingerprints (“FG1” to “FG4”) arranged in sequential order (e.g., in order of arrival of the corresponding data units). Further, the controller generates a second portion fingerprint (“PFG2”) by applying a function to the unit fingerprints (“FG5” to “FG8”) for the second portion (“P2”).

Referring again to FIG. 3, block 340 may include storing the portion fingerprint and the set of fingerprints in a portion mapping (PM). In some implementations, the portion mapping may include multiple PM entries, with each PM entry representing a different portion comprising multiple data units. Further, in some implementations, each PM entry may record the full fingerprint (“FG”) for each data unit included in the corresponding portion. Alternatively, in other implementations, each PM entry may record a truncated fingerprint (“TFG”) for each data unit included in the corresponding portion, where the truncated fingerprint includes a subset (e.g., 2 kilobytes) of the full fingerprint (e.g., 4 kilobytes).

For example, referring to FIG. 4B, shown is a first portion mapping 410A with entries to store the full fingerprint (“FG”) for each data unit included in the corresponding portion. The controller creates a first entry in the first portion mapping 410A to record the first portion (“P1”). As shown, the first entry includes a “Portion FG” field to store the first portion fingerprint (“PFG1”) that identifies the first portion. The first entry also includes a “Count” field to indicate how many data units are included in the first portion (i.e., four data units), and also includes four “Unit FG” fields to record the full unit fingerprints (“FG1” to “FG4”) of the four data units (“U1” to “U4”) that are included in the first portion. Further, the controller creates a second entry in the first portion mapping 410A to record the second portion (“P2”), including a “Portion FG” field to store the second portion fingerprint (“PFG2”), a “Count” field to indicate that the second portion includes four data units, and four “Unit FG” fields to record the full unit fingerprints (“FG5” to “FG8”) of the four data units (“U5” to “U8”) that are included in the second portion.

In another example, referring to FIG. 4C, shown is a second portion mapping 410B with entries to store the truncated fingerprint (“TFG”) for each data unit included in the corresponding portion. Note that the entries in the second portion mapping 410B includes “Unit TFG” fields to record the truncated fingerprints of the data units that are included in the corresponding portion.

Referring again to FIG. 3, block 350 may include storing the set of data units in a CEG object. Block 360 may include storing the set of fingerprints in a metadata section of the CEG object. For example, referring to FIG. 4D, the controller stores copies of the four data units from the first portion (“U1” to “U4”) in the CEG object “A” 450A, and creates four entries in the CEG header 455A. Each entry of the CEG header 455A includes a “Unit ID” field to identify a different data unit stored in the CEG object “A” 450A, and a “Fingerprint” field to store the full unit fingerprints (“FG1” to “FG4”) of the stored data units (“U1” to “U4”). Further, each header entry includes an “Offset” field to indicate the storage location of the corresponding data unit in the CEG object “A” 450A.

In another example, referring to FIG. 4E, the controller stores copies of the four data units from the second portion (“U5” to “U8”) in the CEG object “B” 450B, and creates four entries in the CEG header 455B. Each entry of the CEG header 455B includes a “Unit ID” field to identify a different data unit stored in the CEG object “B” 450B, and a “Fingerprint” field to store the full unit fingerprints (“FG5” to “FG8”) of the stored data units (“US” to “U8”). Further, each header entry includes an “Offset” field to indicate the storage location of the corresponding data unit in the CEG object “B” 450B.

Referring again to FIG. 3, block 370 may include recording the portion fingerprint and the storage location of the portion in a container index (CI) entry. For example, referring to FIG. 4F, the controller records metadata for the first portion in a first CI entry of the container index 430. The first CI entry includes an “ID” field to store an identifier (“P1”) for the first portion, and a “Portion FG” field to store the portion fingerprint (“PFG1”) for the first portion. The first CI entry also includes a “Ref. Count” to store a reference count for the first portion (i.e., indicating the total number of manifest records that reference the first portion). Further, the first CI entry includes “CEG,” “Offset,” and “Length” fields to record the storage location of the first portion (e.g., indicating that the first portion is stored at offset “0” in the CEG object “A” 450A and has a stored length of four data units).

In another example, the controller records metadata for the second portion in a second CI entry of the container index 430. The second CI entry includes an “ID” field to store an identifier (“P2”) for the second portion, and a “Portion FG” field to store the portion fingerprint (“PFG2”) for the second portion. The second CI entry also includes a “Ref. Count” to store a reference count for the second portion. Further, the second CI entry includes “CEG,” “Offset,” and “Length” fields to record the storage location of the second portion (e.g., indicating that the first portion is stored at offset “0” in the CEG object “B” 450B and has a stored length of four data units).

### FIGS. 5A-5B and 6A-6H—Example Process for Deduplication Using Portion Metadata

FIGS. 5A-5B show an example process 500 for deduplication using portion metadata, in accordance with some implementations. In some examples, the process 500 may be performed using the storage controller 110 (shown in FIG. 1). The process 500 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 510 may include reading a data unit in a data stream. Block 515 may include generating a fingerprint (FGs) for the data unit. Block 520 may include comparing the generated fingerprint to entries in a portion mapping (PM). Decision block 522 may include determining whether the generated fingerprint matches a unit fingerprint recorded in a PM entry. Upon a negative determination (“NO”), the process 500 may continue at block 555, including performing deduplication of the data unit. After 555, the process 500 may continue at decision block 552 (described below).

For example, referring to FIG. 6A, a controller (e.g., storage controller 110 shown in FIG. 1) receives a second data stream 402 to be stored in persistent storage. The second data stream 402 may be a subsequent instance of a data stream (e.g., after the initial backup of a collection of data). The controller reads a data unit (“U0”) in the second data stream 402, and generates a data unit fingerprint (“FG0”) by applying a hash function to the data unit. The controller determines that the generated fingerprint (“FG0”) does not match any of the data unit fingerprints stored in the portion mapping 410A (e.g., indicating that the data unit is not included in any of the recorded portions), and in response performs deduplication of the data unit alone (i.e., not as part of a portion). The controller matches the data unit fingerprint (“FG0”) to an existing entry in the container index 430 (i.e., an entry that was previously created to record the data unit “U0”). The controller then increments the reference count for the data unit (“U0”) in the existing entry, thereby recording that the indicating that two instances of the data unit (“U0”) have been stored in deduplicated form.

Referring again to FIG. 5A, if it is determined at decision block 522 that the generated fingerprint matches a data unit fingerprint recorded in a PM entry (“YES”), the process 500 may continue at block 525, including determining a count N of data units recorded in the PM entry (where N is a positive integer greater than one).

For example, referring to FIG. 6B, the controller reads a data unit (“U1”) in the second data stream 402, and generates a data unit fingerprint (“FG1”) by applying a hash function to the data unit. The controller matches the generated fingerprint to a data unit fingerprint (“FG1”) stored in a first entry of the portion mapping 410A (i.e., the PM entry corresponding to the first portion “P1” shown in FIG. 4A). In response to this matching, the controller reads the “Count” field in the matching PM entry, and thereby determines that the number N of data units included in the first portion is four.

Referring again to FIG. 5A, block 530 may include reading the following (N−1) data units in the data stream. Block 535 may include generating a set of N fingerprints. Block 540 may include generating a portion fingerprint (PFG) using the generated set of fingerprints. Decision block 545 may include determining whether the generated PFG matches the PFG stored in the PM entry. Upon a positive determination at decision block 545 (“YES”), the process 500 may continue at block 550, including incrementing a reference count for the portion. After 550, the process 500 may continue at decision block 552 (described below).

For example, referring to FIG. 6C, the controller reads the following three (i.e., N−1) data units (“U2,” “U3,” “U4”) from the second data stream 402. The controller then applies a hash function to each of the data units (“U1,” “U2,” “U3,” “U4”) that have been read, and thereby generates four data unit fingerprints (“FG1,” “FG2,” “FG3,” “FG4”). In some implementations, the controller generates a portion fingerprint (“PFG1”) by applying a hash function to a concatenation of the four data unit fingerprints (“FG1,” “FG2,” “FG3,” “FG4”) in sequential order. The controller then determines that the generated portion fingerprint (“PFG1”) matches the value stored in a “Portion FG” field of a first PM entry on the portion mapping 410A. In response to this determination, the controller accesses the container index 430 and increments the reference count for the first portion (“P1”), thereby recording that the indicating that two instances of the first portion have been stored in deduplicated form.

Referring again to FIG. 5A-5B, if is determined at decision block 545 that the generated PFG does not match the PFG stored in the PM entry (“NO”), the process 500 may continue at block 560 (shown in FIG. 5B), including identifying a container entity group (CEG) object that stores the data units included in the portion. Block 565 may include loading a header portion of the CEG object into memory.

For example, referring to FIG. 6D, the controller reads a data unit (“U5”) in the second data stream 402, and generates a unit fingerprint (“FG5”) by applying a hash function to the data unit. The controller matches the generated fingerprint to a unit fingerprint (“FG5”) stored in a second entry of the portion mapping 410A (i.e., the PM entry corresponding to the second portion “P2” shown in FIG. 4A). In response to this matching, the controller reads the “Count” field in the matching PM entry, and thereby determines that the number N of data units included in the second portion is four.

Referring now to FIG. 6E, the controller reads the following three (i.e., N−1) data units (“U6,” “U9,” “U8”) from the second data stream 402. The controller then applies a hash function to each of the data units (“U5,” “U6,” “U9,” “U8”) that have been read, and thereby generates four data unit fingerprints (“FG5,” “FG6,” “FG9,” “FG8”). Further, the controller generates a portion fingerprint (“PFG3”) by applying a hash function to the four data unit fingerprints (“FG5,” “FG6,” “FG9,” “FG8”). The controller then determines that the generated portion fingerprint (“PFG3”) does not match the “Portion FG” field in the second PM entry of the portion mapping 410A. Note that the set of four fingerprints (“FG5,” “FG6,” “FG9,” “FG8”) that are hashed to generate the new portion fingerprint (“PFG3”) is different from the set of four fingerprints (“FG5,” “FG6,” “FG7,” “FG8”) that were previously hashed to generate the stored portion fingerprint (“PFG2”).

Referring now to FIG. 6F, responsive to determining that the generated portion fingerprint (“PFG3”) does not match the “Portion FG” field in the second PM entry of the portion mapping 410A, the controller reads the container index 430 to determine that the second portion (“P2”) is stored in the container entity group (CEG) object “B” 450B. The controller then loads the CEG header 455 (in the CEG object “B” 450B) into memory (e.g., memory 115 shown in FIG. 1). In some implementations, the CEG header portion may occupy a specified amount of data located at the beginning of a CEG object (e.g., the first 64 kilobytes of the CEG object). In such implementations, the controller may read the specified amount of data from the CEG object (i.e., without reading the remaining portion of the CEG object), and may then parse or otherwise obtain the CEG header portion from this amount of data from the CEG object.

Referring again to FIG. 5B, block 570 may include reading unit metadata from the header portion of the CEG object. Block 575 may include creating container index entries for each data unit using the unit metadata from the header portion. Block 580 may include deleting the container index entry for the portion. Block 585 may include deleting the portion mapping (PM) entry for the portion. After block 585, the process 500 may continue at decision block 552 (shown in FIG. 5A).

For example, referring to FIG. 6G, the controller reads the CEG header 455 (loaded in memory) to obtain metadata for the set of data units (“U5,” “U6,” “U7,” “U8”) that were recorded (e.g., in the portion mapping 410A) as being included in the second portion (“P2”). This metadata may include the data unit fingerprints (“FG5,” “FG6,” “FG7,” “FG8”), the location of each data unit in the CEG object “B,” and any other unit metadata. The controller may then use the obtain metadata to create four new entries in the container index 430, with each new entry including metadata for a different data unit (“U5,” “U6,” “U7,” “U8”). The controller populates each of the container index entries for the four data units (“U5,” “U6,” “U7,” “U8”) with the reference count (“1”) that is equal to the reference count in the container index entry for the portion entry. Further, the controller increments the reference counts for the three data units (“U5,” “U6,” “U8”) by one (i.e., to two), thereby indicating that these three data units were received a second time (i.e., in the second data stream 402).

Referring now to FIG. 6H, the controller deletes the CI entry (in container index 430) that included portion metadata for the second portion (“P2”). Further, the controller deletes the PM entry (in portion mapping 410A) that included mapping information for the second portion (“P2”).

Referring again to FIG. 5A, decision block 552 may include determining whether there are remaining data units to be read in the data stream. Upon a positive determination (“YES”), the process 500 may return to block 510 (i.e., to read another data unit in the data stream). Otherwise, upon a negative determination at decision block 552 (“NO”), the process 500 may be completed.

Note that, if it is determined at decision block 545 that the generated PFG matches the PFG stored in the PM entry, the received portion is not stored in a CEG object (as it is already present in an existing CEG object), thereby avoiding storing a duplicate portion in the storage system. However, if it is determined at decision block 545 that the generated PFG does not match the PFG stored in the PM entry, the portion metadata is removed (i.e., by deleting the PM and CI entries for the portion), and is replaced with unit metadata (in container index entries) for the data units that were included in the portion. In this manner, the portion metadata can be used while the portion is received in the inbound data stream, but can be replaced with the corresponding unit metadata if the portion is no longer received in the inbound data stream.

Note also that FIGS. 6A-6H illustrate example operations using the portion mapping 410A (shown in FIG. 4B) that stores full unit fingerprints (e.g., “FG1,” “FG2,” “FG3,” and so forth). However, other example operations may instead use the portion mapping 410B (shown in FIG. 4C) that stores truncated unit fingerprints (e.g., “TFG1,” “TFG2,” “TFG3,” and so forth). In such examples, the process 500 may be modified to include steps (not shown in FIGS. 5A-5B) to generate and use truncated unit fingerprints. For example, step 520 may include generating a truncated fingerprint by truncating the fingerprint of the data unit, and then comparing the generated truncated fingerprint to stored truncated unit fingerprints in the portion mapping 410B. In another example, step 540 may include generating a set of truncated fingerprints by truncating the set of N unit fingerprints, and then generating the portion fingerprint using the set of truncated fingerprints. Other adjustments or variations are possible.

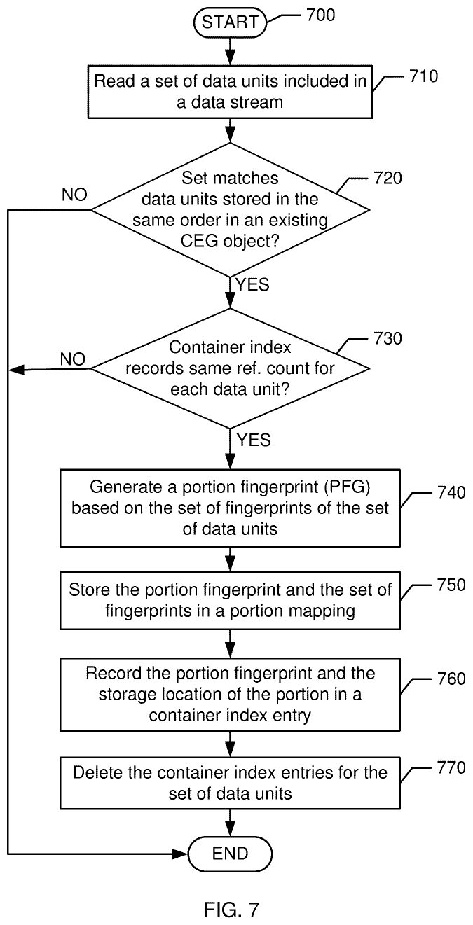

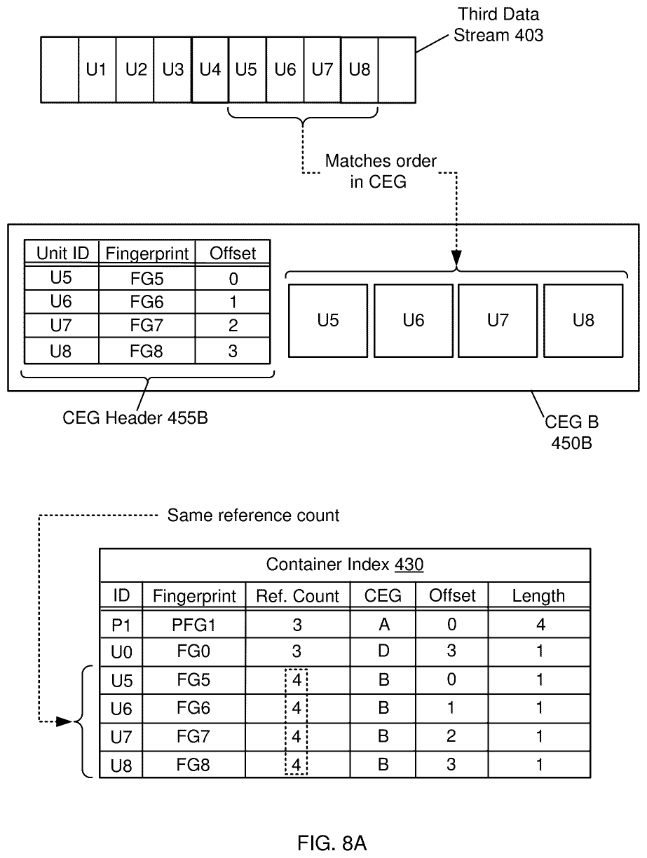

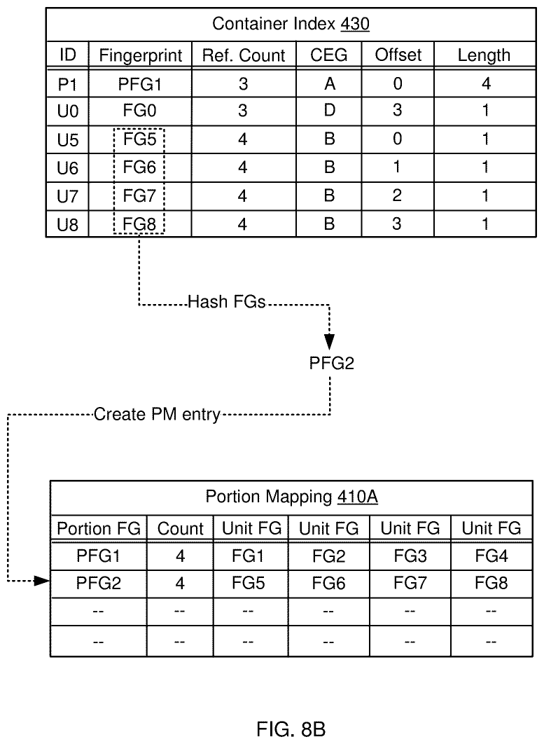

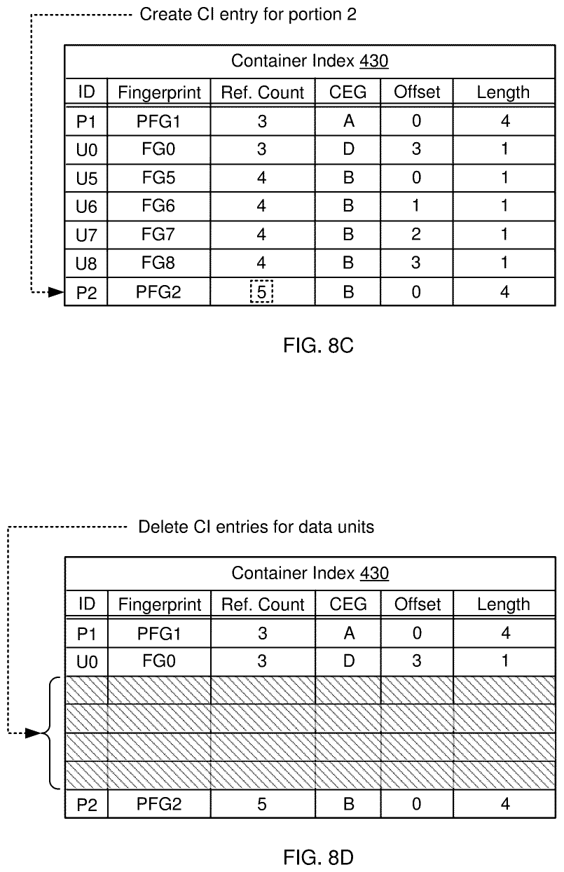

### FIGS. 7 and 8A-8D—Example Process for Generating Portion Metadata

FIG. 7 shows is an example process 700 for generating portion metadata, in accordance with some implementations. In some examples, the process 700 may be performed using the storage controller 110 (shown in FIG. 1). The process 700 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 710 may include reading a set of data units included in a data stream. Decision block 720 may include determining whether the set matches data units stored in the same order in an existing container entity group (CEG) object. Upon a negative determination at decision block 720 (“NO”), the process 700 may be completed. Otherwise, upon a positive determination at decision block 720 (“YES”), the process 700 may continue at decision block 730, including determining whether a container index records the same reference count for each data unit. Upon a negative determination at decision block 730 (“NO”), the process 700 may be completed. Otherwise, upon a positive determination at decision block 730 (“YES”), the process 700 may continue at block 740 (described below).

For example, referring to FIG. 8A, a controller (e.g., storage controller 110 shown in FIG. 1) receives a third data stream 403 to be stored in persistent storage. The third data stream 403 may be a subsequent instance of a data stream (e.g., after receiving the second data stream 402 shown in FIG. 6A). The controller reads a set of data units (“U5,” “U6,” “U7,” “U8”) in the third data stream 403, and determines that the same sequence of data units is stored, in the same order, in the CEG object B 450B. The controller then determines that the reference counts of the data units (stored in the corresponding entries of the container index 430) all have the same value (i.e., one).

Referring again to FIG. 7, block 740 may include generating a portion fingerprint (PFG) based on the set of fingerprints of the set of data units. Block 750 may include storing the portion fingerprint and the set of fingerprints in a portion mapping (PM).

For example, referring to FIG. 8B, the controller reads the data unit fingerprints (“FG5,” “FG6,” “FG7,” “FG8”) from the corresponding entries of the container index 430. The controller then generates the second portion fingerprint (“PFG2”) by applying a hash function to the data unit fingerprints. Further, the controller creates a PM entry (in portion mapping 410A) to record the portion (“P2”), including a “Portion FG” field to store the portion fingerprint (“PFG2”), a “Count” field to indicate that the portion includes four data units, and four “Unit FG” fields to record the unit fingerprints (“FG5” to “FG8”) of the four data units (“U5” to “U8”) that are included in the portion.

Referring again to FIG. 7, block 760 may include recording the portion fingerprint and the storage location of the portion in a container index (CI) entry. Block 770 may include deleting the CI entries for the set of data units. After block 770 the process 700 ay be completed. For example, referring to FIG. 8C, the controller records metadata for the portion (“P2”) in a new CI entry of the container index 430. Note that, in the example shown in FIG. 8C, the new CI entry includes a reference count equal to two, thereby indicating that the reference counts of the data units (i.e., one) has been incremented by one to reflect that another instance of the set of data units has been received (i.e., in the third data stream 403). Further, referring to FIG. 8D, the controller deletes the CI entries for the set of data units (“U5,” “U6,” “U7,” “U8”).

In some implementations, the process 700 may be performed to generate a portion based on any number of multiple data units (i.e., two or more data units) that are received in a data stream. However, in other implementations, the process 700 may performed only to generate portions that include at least a minimum threshold number of data units (e.g., at least 5, 10, etc.). In such implementations, the minimum threshold number may be specified by a configuration setting, program variable, and so forth. For example, the minimum threshold number may be set by a user command to reduce the amount of number of portions that are repeatedly regenerated and then deleted over time.

Note that FIGS. 8A-8D illustrate example operations using the portion mapping 410A (shown in FIG. 4B) that stores full unit fingerprints (e.g., “FG1,” “FG2,” “FG3,” and so forth). However, other example operations may instead use the portion mapping 410B (shown in FIG. 4C) that stores truncated unit fingerprints (e.g., “TFG1,” “TFG2,” “TFG3,” and so forth). In such examples, the process 700 may be modified to include steps (not shown in FIG. 7) to generate and use truncated unit fingerprints. For example, step 740 may include generating a set of truncated fingerprints by truncating the set of unit fingerprints, and then generating the portion fingerprint using the set of truncated fingerprints. Other adjustments or variations are possible.

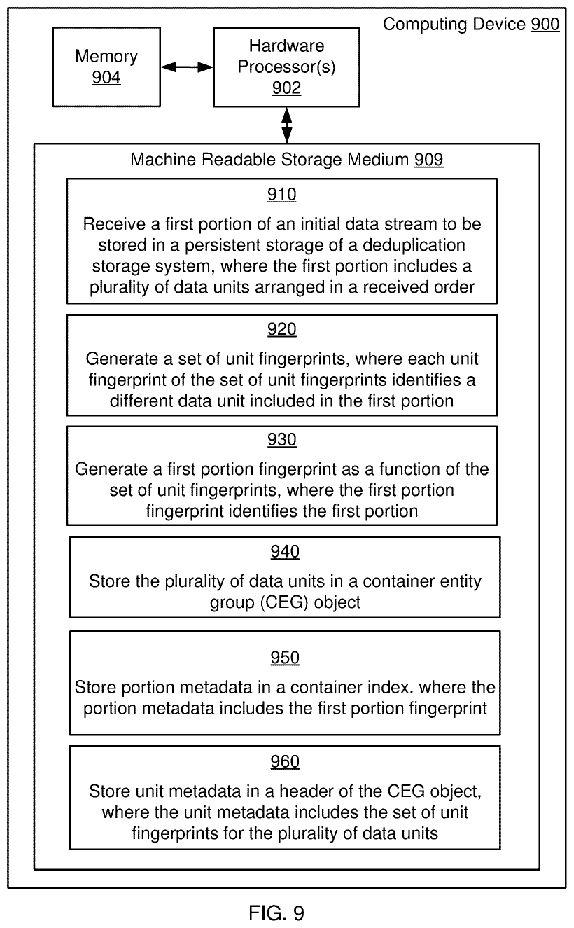

### FIG. 9—Example Computing Device

FIG. 9 shows a schematic diagram of an example computing device 900. In some examples, the computing device 900 may correspond generally to some or all of the storage system 100 (shown in FIG. 1). As shown, the computing device 900 may include a hardware processor 902, a memory 904, and machine-readable storage 905 including instructions 910-960. The machine-readable storage 905 may be a non-transitory medium. The instructions 910-960 may be executed by the hardware processor 902, or by a processing engine included in hardware processor 902.

Instruction 910 may be executed to receive a first portion of an initial data stream to be stored in a persistent storage of a deduplication storage system, where the first portion includes a plurality of data units arranged in a received order. Instruction 920 may be executed to generate a set of unit fingerprints, where each unit fingerprint of the set of unit fingerprints identifies a different data unit included in the first portion. Instruction 930 may be executed to generate a first portion fingerprint as a function of the set of unit fingerprints, where the first portion fingerprint identifies the first portion.

Instruction 940 may be executed to store the plurality of data units in a container entity group (CEG) object. Instruction 950 may be executed to store portion metadata in a container index, where the portion metadata includes the first portion fingerprint. Instruction 960 may be executed to store unit metadata in a header of the CEG object, where the unit metadata includes the set of unit fingerprints for the plurality of data units.

For example, referring to FIG. 4A, a controller (e.g., storage controller 110 shown in FIG. 1) receives an initial data stream 400 that includes a first portion (“P1”) made up of four data units (“U1,”“U2,”“U3,”“U4”). The controller generates unit fingerprints (“FG1,”“FG2,” “FG3,” “FG4”) by applying a function (e.g., a hash function) to the received data units. The controller then generates a first portion fingerprint (“PFG1”) by applying a hash function to the unit fingerprints.

Referring now to FIG. 4B, the controller creates a first entry in the first portion mapping 410A to record the first portion (“P1”). The first entry includes a “Portion FG” field to store the first portion fingerprint (“PFG1”) that identifies the first portion. The first entry also includes a “Count” field to indicate how many data units are included in the first portion (i.e., four data units), and also includes four “Unit FG” fields to record the unit fingerprints of the four data units that are included in the first portion.

Referring now to FIG. 4D, the controller stores copies of the four data units from the first portion (“U1” to “U4”) in the CEG object “A” 450A, and creates four entries in the CEG header 455A. Each entry of the CEG header 455A includes a “Unit ID” field to identify a different data unit stored in the CEG object “A” 450A, and a “Fingerprint” field to store the unit fingerprints (“FG1” to “FG4”) of the stored data units (“U1” to “U4”). Further, each header entry includes an “Offset” field to indicate the storage location of the corresponding data unit in the CEG object “A” 450A.

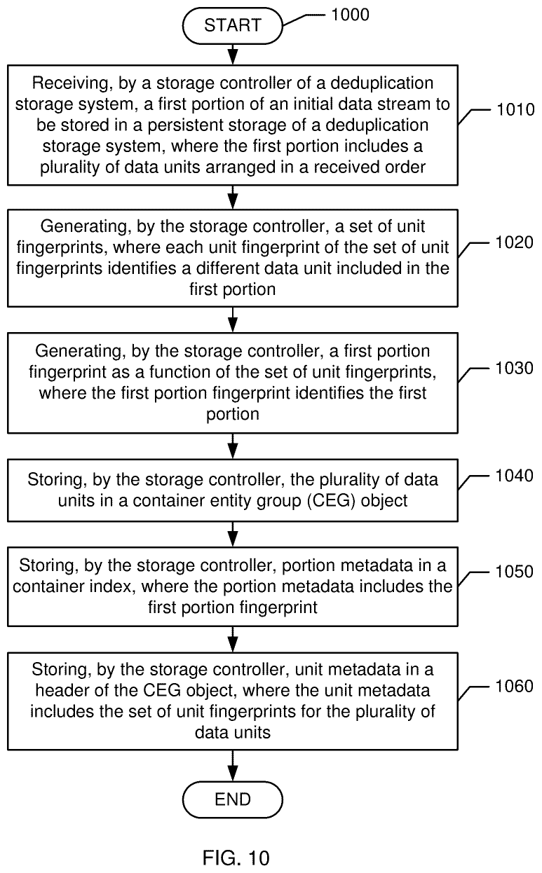

### FIG. 10—Example Process for Generating Metadata

FIG. 10 shows is an example process 1000 for generating metadata of a deduplication storage system, in accordance with some implementations. In some examples, the process 1000 may be performed using the storage controller 110 (shown in FIG. 1). The process 1000 may be implemented in hardware or a combination of hardware and programming (e.g., machine-readable instructions executable by a processor(s)). The machine-readable instructions may be stored in a non-transitory computer readable medium, such as an optical, semiconductor, or magnetic storage device. The machine-readable instructions may be executed by a single processor, multiple processors, a single processing engine, multiple processing engines, and so forth.

Block 1010 may include receiving, by a storage controller of a deduplication storage system, a first portion of an initial data stream to be stored in a persistent storage of a deduplication storage system, where the first portion includes a plurality of data units arranged in a received order. Block 1020 may include generating, by the storage controller, a set of unit fingerprints, where each unit fingerprint of the set of unit fingerprints identifies a different data unit included in the first portion. Block 1030 may include generating, by the storage controller, a first portion fingerprint as a function of the set of unit fingerprints, where the first portion fingerprint identifies the first portion.

Block 1040 may include storing, by the storage controller, the plurality of data units in a container entity group (CEG) object. Block 1050 may include storing, by the storage controller, portion metadata in a container index, where the portion metadata includes the first portion fingerprint. Block 1060 may include storing, by the storage controller, unit metadata in a header of the CEG object, where the unit metadata includes the set of unit fingerprints for the plurality of data units. Blocks 1010-1060 may correspond generally to the examples described above with reference to instructions 910-960 (shown in FIG. 9).

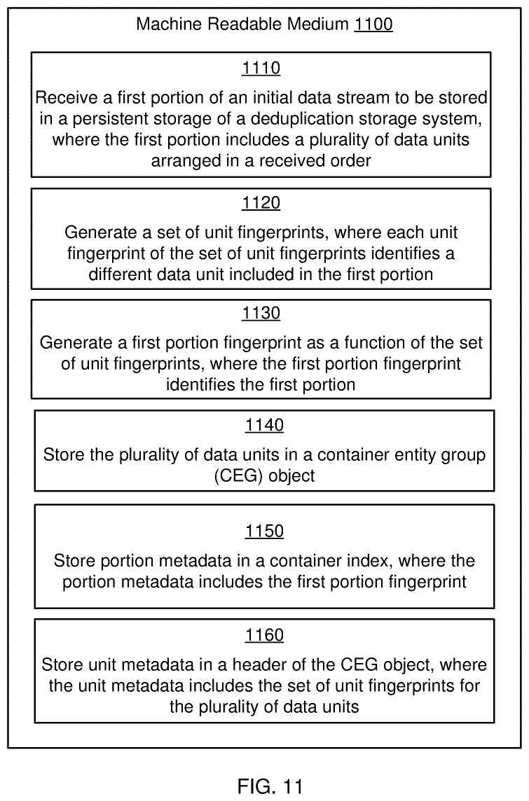

### FIG. 11—Example Machine-Readable Medium

FIG. 11 shows a machine-readable medium 1100 storing instructions 1110-1160, in accordance with some implementations. The instructions 1110-1160 can be executed by a single processor, multiple processors, a single processing engine, multiple processing engines, and so forth. The machine-readable medium 1100 may be a non-transitory storage medium, such as an optical, semiconductor, or magnetic storage medium. The instructions 1110-1160 may correspond generally to the examples described above with reference to instructions 910-960 (shown in FIG. 9).

Instruction 1110 may be executed to receive a first portion of an initial data stream to be stored in a persistent storage of a deduplication storage system, where the first portion includes a plurality of data units arranged in a received order. Instruction 1120 may be executed to generate a set of unit fingerprints, where each unit fingerprint of the set of unit fingerprints identifies a different data unit included in the first portion. Instruction 1130 may be executed to generate a first portion fingerprint as a function of the set of unit fingerprints, where the first portion fingerprint identifies the first portion.

Instruction 1140 may be executed to store the plurality of data units in a container entity group (CEG) object. Instruction 1150 may be executed to store portion metadata in a container index, where the portion metadata includes the first portion fingerprint. Instruction 1160 may be executed to store unit metadata in a header of the CEG object, where the unit metadata includes the set of unit fingerprints for the plurality of data units.

### Conclusion

In accordance with some implementations of the present disclosure, a controller of a deduplication storage system may receive a data stream portion including a sequence of multiple data units. Each data unit may be represented by unit metadata, and the portion may be represented by portion metadata. For example, the portion metadata may include a portion fingerprint that is generated by applying a function to a set of unit fingerprints that represent the data units in the portion. In some implementations, the controller may compare the portion fingerprint to fingerprints stored in a container index. If no matching fingerprints are found in the searched container index, the received portion may be stored in a container entity group (CEG) object, and the portion metadata may be stored in a container index entry. Further, the unit metadata may be stored in the CEG object header. Otherwise, if a matching fingerprint is found in a searched container index, it may be determined that an identical portion is already stored in an existing CEG object. In response to this determination, the reference count for the portion may be incremented, and the received portion is not stored in a CEG object, thereby avoiding storing a duplicate copy of the portion. In this manner, the storage system may deduplicate the received data using a relatively large size (e.g., as a portion), while only using a single container index entry to represent the entire portion. Further, if it is determined that one or more data units in a received portion no longer match the stored portion, the unit metadata may be extracted from the CEG object header, and the unit metadata may be used to replace the container index entry for the portion with a set of the container index entries for the data units. Accordingly, if the portion metadata is no longer suitable for matching operations, the storage system may modify one or more metadata structures to perform matching operations using unit metadata.

Note that, while FIGS. 1-11 show various examples, implementations are not limited in this regard. For example, referring to FIG. 1, it is contemplated that the functionality of the storage controller 110 described above may be included in any another engine or software of storage system 100. Other combinations and/or variations are also possible.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A computing device comprising:
a processor;
a memory; and
a machine-readable storage storing instructions, the instructions executable by the processor to:
receive a first portion of an initial data stream to be stored in a persistent storage of a deduplication storage system, wherein the first portion includes a first set of data units, the first set of data units including a plurality of data units arranged in a received order;
generate a set of unit fingerprints, wherein each unit fingerprint of the set of unit fingerprints identifies a different data unit included in the first portion;
generate a first portion fingerprint as a function of the set of unit fingerprints, wherein the first portion fingerprint identifies the first portion;
store the first set of data units in a container entity group (CEG) object;
store portion metadata in a container index, wherein the portion metadata includes the first portion fingerprint;
store unit metadata in a header of the CEG object, wherein the unit metadata includes the set of unit fingerprints for the first set of data units;
receive a second portion of a second data stream;
generate a second portion fingerprint based on the second portion; and
determine, based on a comparison of the second portion fingerprint to the first portion fingerprint, whether the second portion is already stored in the deduplication storage system.

2. The computing device of claim 1, including instructions executable by the processor to:
store the first portion fingerprint and the set of unit fingerprints in a first entry of a portion mapping structure.

3. The computing device of claim 2, including instructions executable by the processor to:
read a first data unit in the second portion of the second data stream;
generate a first unit fingerprint for the first data unit; and
compare the generated first unit fingerprint to one or more entries in the portion mapping structure.

4. The computing device of claim 3, including instructions executable by the processor to, in response to a determination that the generated first unit fingerprint matches one of the unit fingerprints stored in the first entry of the portion mapping structure:
determine a count of data units included in the first portion;
read one or more following data units in the second data stream;
generate a second set of unit fingerprints based on a second set of data units, wherein a total number of the second set of data units is equal to the determined count, and wherein the second set of data units includes the first data unit and the one or more following data units;
generate the second portion fingerprint using the second set of unit fingerprints; and
compare the second portion fingerprint to the first portion fingerprint stored in the first entry of the portion mapping structure.

5. The computing device of claim 4, including instructions executable by the processor to, in response to a determination that the second portion fingerprint matches the first portion fingerprint stored in the first entry of the portion mapping structure:
increment, in the portion metadata stored in the container index, a reference count for the first portion.

6. The computing device of claim 4, including instructions executable by the processor to, in response to a determination that the second portion fingerprint does not match the first portion fingerprint stored in the first entry of the portion mapping structure:
read the unit metadata stored in the header of the CEG object;
create, using the unit metadata, container index entries for the first set of data units stored in the CEG object;
delete the portion metadata stored in the container index; and
delete the first entry of the portion mapping structure.

7. The computing device of claim 3, including instructions executable by the processor to, in response to a determination that the generated first unit fingerprint does not match any unit fingerprints stored in the one or more entries in the portion mapping structure:
compare the generated first unit fingerprint to at least one unit fingerprint stored in the container index.

8. The computing device of claim 2, including instructions executable by the processor to:
receive third portion of a third data stream, wherein the third portion includes a third set of data units;
in response to a determination that the third set of data units is stored, in the same order, in the CEG object:
determine whether each data unit of the third set of data units has a same reference count;
in response to a determination that each data unit of the third set of data units has the same reference count, generate a third portion fingerprint based on unit fingerprints of the third set of data units;
store the third portion fingerprint in a second entry of the portion mapping structure;
record the third portion fingerprint in a new container index entry for the third portion; and
delete container index entries for the third set of data units.

9. A method comprising:
receiving, by a storage controller of a deduplication storage system, a first portion of an initial data stream to be stored in a persistent storage of a deduplication storage system, wherein the first portion includes a first set of data units, the first set of data units including a plurality of data units arranged in a received order;
generating, by the storage controller, a set of unit fingerprints, wherein each unit fingerprint of the set of unit fingerprints identifies a different data unit included in the first portion;
generating, by the storage controller, a first portion fingerprint as a function of the set of unit fingerprints, wherein the first portion fingerprint identifies the first portion;
storing, by the storage controller, the first set of data units in a container entity group (CEG) object;
storing, by the storage controller, portion metadata in a container index, wherein the portion metadata includes the first portion fingerprint;
storing, by the storage controller, unit metadata in a header of the CEG object, wherein the unit metadata includes the set of unit fingerprints for the first set of data units;
receiving, by the storage controller, a second portion of a second data stream;
generating, by the storage controller, a second portion fingerprint based on the second portion; and
determining by the storage controller, based on a comparison of the second portion fingerprint to the first portion fingerprint, whether the second portion is already stored in the deduplication storage system.

10. The method of claim 9, comprising:
storing the first portion fingerprint and the set of unit fingerprints in a first entry of a portion mapping structure.

11. The method of claim 10, comprising:
reading a first data unit in the second portion of the second data stream;
generating a first unit fingerprint for the first data unit; and
comparing the generated first unit fingerprint to one or more entries in the portion mapping structure.

12. The method of claim 11, comprising, in response to a determination that the generated first unit fingerprint matches one of the unit fingerprints stored in the first entry of the portion mapping structure:
determining a count of data units included in the first portion;
reading one or more following data units in the second data stream;
generating a second set of unit fingerprints based on a second set of data units, wherein a total number of the second set of data units is equal to the determined count, and wherein the second set of data units includes the first data unit and the one or more following data units;
generating the second portion fingerprint using the second set of unit fingerprints; and
comparing the second portion fingerprint to the first portion fingerprint stored in the first entry of the portion mapping structure.

13. The method of claim 12, comprising, in response to a determination that the second portion fingerprint matches the first portion fingerprint stored in the first entry of the portion mapping structure:
incrementing, in the portion metadata stored in the container index, a reference count for the first portion.

14. The method of claim 12, comprising, in response to a determination that the second portion fingerprint does not match the first portion fingerprint stored in the first entry of the portion mapping structure:
reading the unit metadata stored in the header of the CEG object;
creating, using the unit metadata, container index entries for the first set of data units stored in the CEG object;
deleting the portion metadata stored in the container index; and
deleting the first entry of the portion mapping structure.

15. A non-transitory machine-readable medium storing instructions that upon execution cause a processor to:
receive a first portion of an initial data stream to be stored in a persistent storage of a deduplication storage system, wherein the first portion includes a first set of data units, the first set of data units including a plurality of data units arranged in a received order;
generate a set of unit fingerprints, wherein each unit fingerprint of the set of unit fingerprints identifies a different data unit included in the first portion;
generate a first portion fingerprint as a function of the set of unit fingerprints, wherein the first portion fingerprint identifies the first portion;
store the first set of data units in a container entity group (CEG) object;
store portion metadata in a container index, wherein the portion metadata includes the first portion fingerprint;
store unit metadata in a header of the CEG object, wherein the unit metadata includes the set of unit fingerprints for the first set of data units;
receive a second portion of a second data stream;
generate a second portion fingerprint based on the second portion; and
determine, based on a comparison of the second portion fingerprint to the first portion fingerprint, whether the second portion is already stored in the deduplication storage system.

16. The non-transitory machine-readable medium of claim 15, including instructions that upon execution cause the processor to:
store the first portion fingerprint and the set of unit fingerprints in a first entry of a portion mapping structure.

17. The non-transitory machine-readable medium of claim 16, including instructions that upon execution cause the processor to:
read a first data unit in the second portion of the second data stream;
generate a first unit fingerprint for the first data unit; and
compare the generated first unit fingerprint to one or more entries in the portion mapping structure.

18. The non-transitory machine-readable medium of claim 17, including instructions that upon execution cause the processor to, in response to a determination that the generated first unit fingerprint matches one of the unit fingerprints stored in the first entry of the portion mapping structure:
determine a count of data units included in the first portion;
read one or more following data units in the second data stream;
generate a second set of unit fingerprints based on a second set of data units, wherein a total number of the second set of data units is equal to the determined count, and wherein the second set of data units includes the first data unit and the one or more following data units;
generate the second portion fingerprint using the second set of unit fingerprints; and
compare the second portion fingerprint to the first portion fingerprint stored in the first entry of the portion mapping structure.

19. The non-transitory machine-readable medium of claim 18, including instructions that upon execution cause the processor to, in response to a determination that the second portion fingerprint matches the first portion fingerprint stored in the first entry of the portion mapping structure:
increment, in the portion metadata stored in the container index, a reference count for the first portion.

20. The non-transitory machine-readable medium of claim 18, including instructions that upon execution cause the processor to, in response to a determination that the second portion fingerprint does not match the first portion fingerprint stored in the first entry of the portion mapping structure:
read the unit metadata stored in the header of the CEG object;
create, using the unit metadata, container index entries for the first set of data units stored in the CEG object;
delete the portion metadata stored in the container index; and
delete the first entry of the portion mapping structure.
